(19) United States
(12) Patent Application Publication
(10) Pub. No.: US 2003/0220110 A1
(43) Pub. Date: Nov. 27, 2003

(54) Information transmission and reception system capable of accounting for intentions of information provider and information receiver

(75) Inventors: Toshiki Kizu, Kanagawa (JP); Yoshiaki Takabatake, Kanagawa (JP); Yuzo Tamada, Kanagawa (JP)

Correspondence Address: FOLEY AND LARDNER, SUITE 500, 3000 K STREET NW, WASHINGTON, DC, 20007, US

(73) Assignee: KABUSHIKI KAISHA TOSHIBA

(21) Appl. No.: 10/395,845

(22) Filed: Mar. 25, 2003

(30) Foreign Application Priority Data
Mar. 26, 2002 (JP) P2002-085933

(51) Int. Cl. H04Q 7/20

(52) U.S. Cl. 455/445; 455/422.1; 455/41.1

(57) ABSTRACT

In an information transmission and reception system formed by an information providing device for providing information of an information provider to an information receiver through a network and a plurality of relay devices connected to the network, each relay device having at least one of two or more different radio interfaces, and an information receiving device for receiving the information, a related information for selecting one of the different radio interfaces is stored at the information providing device, and the information is transmitted and received through one relay device that has one radio interface specified by the related information.

### BACKGROUND OF THE INVENTION

1. Field of the Invention

The present invention relates to an information providing device, an information receiving device, and an information transmission and reception system.

2. Description of the Related Art

The system for transmitting and receiving information with respect to unspecified many includes the World Wide Web. In recent years, due to the advances of the network technology and the computer technology, it becomes possible for a computer to transmit and receive information via a network at high speed, and it is becoming possible to utilize various media such as a radio LAN (Local Area Network) besides a wired connection to the network.

In addition, due to the advances of the computer technology and the network infrastructure, it is becoming possible to transmit and receive video and audio information that has been impossible conventionally. In particular, the advance of the radio medium technology is significant, and it is becoming possible to transmit and receive information with a large information amount such as video and audio information via the radio medium. Also, a service for providing radio access points called hot spots on the streets, and transmitting and receiving information by accessing at the access point is becoming popular.

Conventionally, it has been possible to transmit and receive Information such as video and audio information by utilizing various media, but what has been possible is only to simply transmit and receive information, and there has been no consideration on the intentions of a side that provides information and a side that receives information.

For example, there exists a service for delivering video and audio information in real time such as the Real Networks service, but in this service the congestion level of the traffic between the delivery server and a receiving side computer is monitored and an amount of video and audio information is changed depending on the congestion level in order to deliver the video and audio information without any interruption. This implies that the information amount is changed regardless of the intentions of the video and audio information provider and receiver, and it is impossible to realize desires such as a desire to provide this video in high quality or a desire to receive this video in best possible quality.

Also, in the case where a device on a side for receiving information receives information by using a radio interface, it is affected not only by the variation of the congestion level of the traffic on the network but also by the variation of the radio state, and in particular there has been a problem that the intolerable delay or the disconnection occurs when the variation of the information amount that can be received in a unit time becomes large.

### BRIEF SUMMARY OF THE INVENTION

It is therefore an object of the present invention to provide an information providing device, an information receiving device, and an information transmission and reception system capable of meeting various demands of the information provider and the information receiver event when the information amount that can be transmitted and received varies.

According to one aspect of the present invention there is provided an information providing device for providing information of an information provider to an information receiver through a network and a plurality of relay devices connected to the network, each relay device having at least one of two or more different radio interfaces, the information providing device comprising: an information storage unit configured to store the information; an information management unit configured to manage the information stored in the information storage unit; a related information memory unit configured to store a related information for selecting one of the different radio interfaces when the information provider transmits the information to the information receiver; and a processing unit configured to carry out a processing when a transmission request for the information is received from the information receiver, to inquire whether the information is stored or not to the information management unit, receive the information from the information storage unit if the information is stored, receive the related information for the information from the related information memory unit, and transmit the information through one relay device that has one radio interface specified by the related information.

According to another aspect of the present invention there is provided an information providing device for providing information of an information provider to an information receiver through a network and any of a plurality of relay devices connected to the network, each relay device having at least one of two or more different radio interfaces, the information providing device comprising: an information storage unit configured to store the information; an information management unit configured to manage the information stored in the information storage unit; a related information memory unit configured to store a related information for selecting one of the different radio interfaces when the information provider transmits the information to the information receiver; a detection unit configured to detect that the information receiver entered a radio area covered by some relay devices; and a processing unit configured to carry out a processing to inquire whether the information related to this radio area is stored or not to the information management unit, receive the information from the information storage unit if the information is stored, receive the related information for the information from the related information memory unit, and transmit the information through one relay device that has one radio interface specified by the related information.

According to another aspect of the present invention there is provided an information receiving device for receiving information of an information provider through a network and any of a plurality of relay devices connected to the network, each relay device having at least one of two or more different radio interfaces, the information receiving device comprising: a plurality of radio interfaces which are mutually different and to be connected to the relay devices through radio; an information request unit configured to request a desired information provided by the information provider, through one of the radio interfaces; a related information receiving unit configured to receive a related information for selecting the one of the radio interfaces, through the one of the radio interfaces at a time of receiving the desired information; a receiving status monitoring unit configured to judge whether a communication using one radio interface specified by the related information is possible or not; and an information receiving unit configured to receive the desired information through the one radio interface, when the receiving status monitoring unit judges that the communication using the one radio interface is possible.

According to another aspect of the present invention there is provided an, information transmission and reception system comprising: an information providing device for providing information of an information provider to an information receiver through a network and a plurality of relay devices connected to the network, each relay device having at least one of two or wore different radio interfaces; and an information receiving device for receiving the information; the information providing device having: an information storage unit configured to store the information; an information management unit configured to manage the information stored in the information storage unit; a related information memory unit configured to store a related information for selecting one of the different radio interfaces when the information provider transmits the information to the information receiver; and a processing unit configured to carry out a processing when a transmission request for the information is received from the information receiver, to inquire whether the information is stored or not to the information management unit, receive the information from the information storage unit if the information is stored, receive the related information for the information from the related information memory unit, and transmit the information through one relay device that has one radio interface specified by the related information; and the information receiving device having: a plurality of radio interfaces which are mutually different and to be connected to the relay devices through radio; an information request unit configured to request a desired information provided by the information provider, through one of the radio interfaces; a related information receiving unit configured to receive the related information for selecting one radio interface, through the one of the radio interfaces, at a time of receiving the desired information; a receiving status monitoring unit configured to judge whether a communication using one radio interface specified by the related information is possible or not; and an information receiving unlit configured to receive the desired information through the one radio interface, when the receiving status monitoring unit judges that the communication using the one radio interface is possible.

Other features and advantages of the present invention will become apparent from the following description taken in conjunction with the accompanying drawings.

### BRIEF DESCRIPTION OF THE DRAWINGS

FIG. 1 is a block diagram showing a configuration of an information transmission and reception system according to one embodiment of the present invention.

FIG. 2 is a block diagram showing a configuration of a server according to one embodiment of the present invention.

FIG. 3 is a diagram showing an exemplary information managed in an information management unit in the server of FIG. 2.

FIG. 4 is a flow chart showing a processing procedure in the case of storing information into the server of FIG. 2.

FIG. 5 is a diagram showing an exemplary information stored in an intention (related information) memory unit in the server of FIG. 2.

FIGS. 6A and 6B are diagrams showing exemplary information to be delivered by the server of FIG. 2.

FIG. 7 is a flow chart showing an operation of the server of FIG. 2.

FIG. 8 is a block diagram showing a configuration of an information receiving device according to one embodiment of the present invention.

FIG. 9 is a diagram showing an exemplary intention (related information) stored in an intention (related information) memory unit in the information receiving device of FIG. 8.

FIG. 10 is a flow chart showing a first half of an operation of the information receiving device of FIG. 8.

FIG. 11 is a flow chart showing a second half of an operation of the information receiving device of FIG. 8.

FIG. 12 is a block diagram showing a configuration of an access point according to one embodiment of the present invention.

FIG. 13 is a flow chart showing a first half of an operation of the access point of FIG. 12 in the case of making a connection.

FIG. 14 is a flow chart showing a second half of an operation of the access point of FIG. 12 in the case of making a connection.

### DETAILED DESCRIPTION OF THE INVENTION

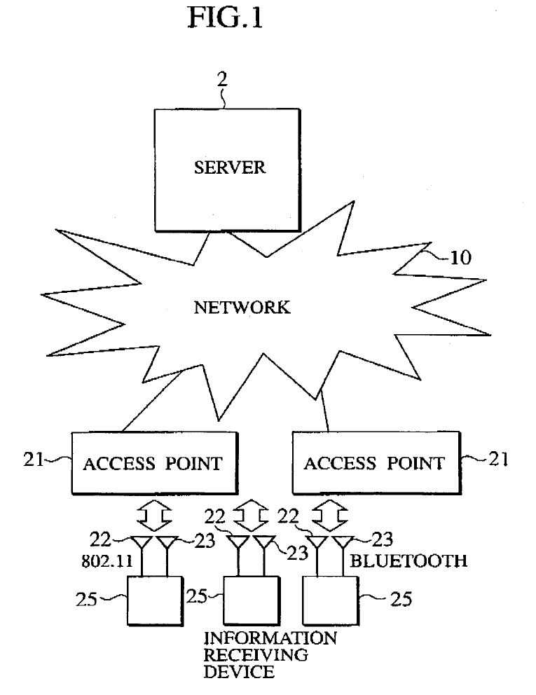

Referring now to FIG. 1 to FIG. 14, one embodiment of the present invention will be described in detail.

FIG. 1 shows a configuration of an information transmission and reception system according to one embodiment of the present invention. The information transmission and reception system of this embodiment has a server 2 to be utilized by an information provider in order to deliver information, a network 10, at least one access point (relay device) 21, and an information receiving device 25 owned by an information receiver.

The server 2 has a function for storing information, a function for delivering the stored information according to a request of the information receiver, and a function for storing an intention (related information) of the information provider. The information receiving device 25 has a plurality of network interfaces such as an 802.11 network interface 22 and a Bluetooth (registered trademark) interface 23, and a function for storing an intention (related information) of the information receiver. The access point 21 carries out communications within the server 2 through the network 10, and has a plurality of network interfaces such as those of 802.11 and Bluetooth (registered trademark) for carrying out communications with the information receiver through the information receiving device 25, a function for accounting for the intentions (related information) of the information provider and the information receiver, and a function for comprehending the number of devices owned by the information receivers that are connected to each network interface in real time.

In this embodiment, the exemplary case where the information provider carries out the stream delivery of continuous information such as video and audio information will be described. In this case, the intention (related information) of the information provider includes the quality of the video image and the audio sound. Namely, the amount of information becomes larger when there is an intention (related information) for desiring to provide information in high quality, and the information amount becomes smaller otherwise.

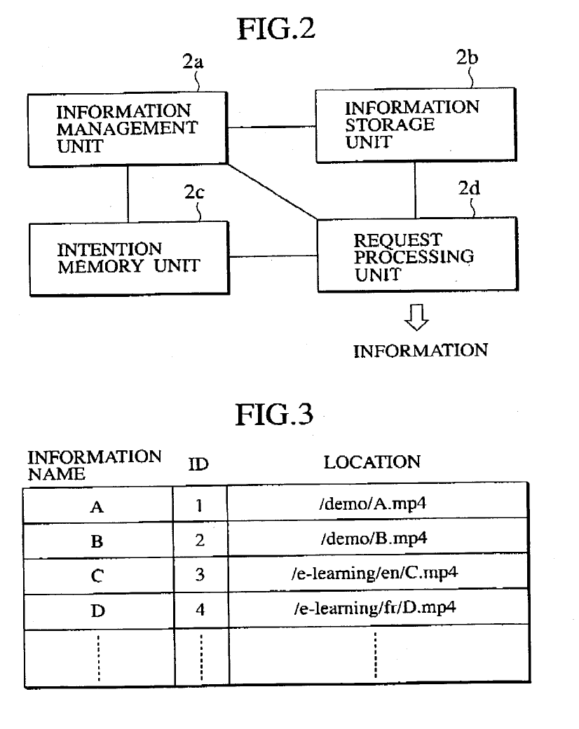

First, the server 2 according to the information transmission and reception system of this embodiment will be described FIG. 2 shows a configuration of the server 2 in this embodiment. As shown in FIG. 2, the server 2 has an information management unit 2a, an information storage unit 2b, an intention memory unit (related information memory unit) 2c, and a request processing unit 2d.

The information provider stores information such as video and audio information into the information storage unit 2b of the server 2. The information storage unit 2b can be a magnetic disk, a magneto-optical disk, a semiconductor memory device, etc. The information to be stored into the server 2 is attached with an identifier for uniquely identifying that information, and the information management unit 2a manages the identifier and the location in the server 2 at which that information is stored. FIG. 3 snows an exemplary information managed by the information management unit 2a. As shown in FIG. 3, the information managed by the information management unit 2a includes an information name, an identifier (ID), and a storing location.

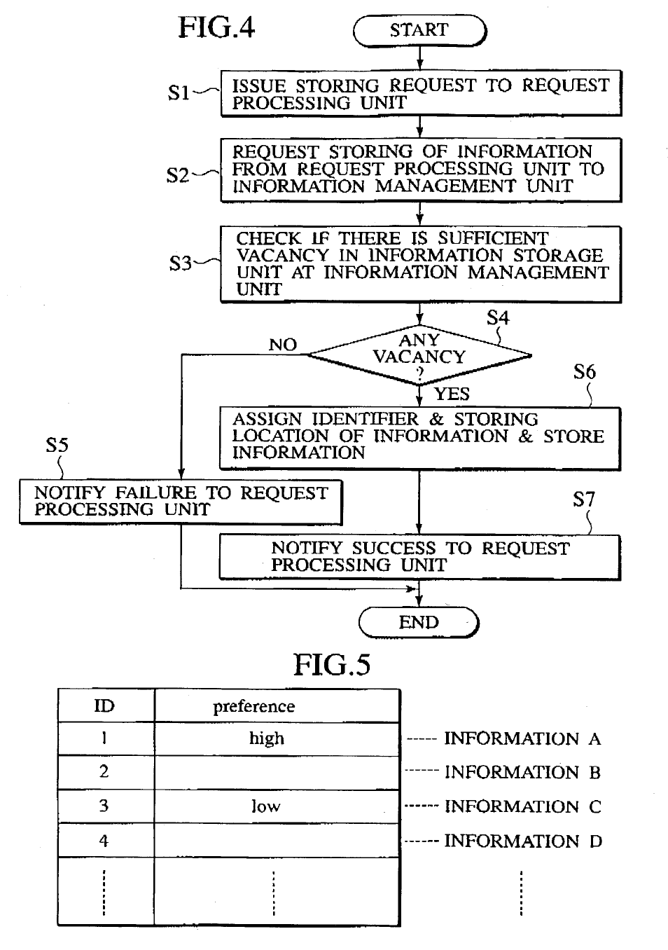

FIG. 4 shows an operation to be carried out when the information provider stores information into the information storage unit 2b inside the server 2. First, at the step S1, the information provider issues a storing request to the request processing unit 2d. Then, at the step S2, the request processing unit 2d requests the storing of the information to the information management unit 2a. Then, at the steps S3 and S4, the information management unit 2a checks whether there is a sufficient vacancy in the information storage unit 2b or not. If a sufficient vacancy is not available, the information management unit 2a notifies the failure of the storing request to the request processing unit 2d at the step S5. If a sufficient vacancy is available, the information management unit 2a assigns the identifier and the storing location of the information and stores the information at the step S6. Then, at the step S7, the information management unit 2a notifies the success of the storing to the request processing unit 2d.

Also, at a time of storing the information, the intention (related information) of the information provider is recorded for each information, in the intention (related information) memory unit 2c inside the server 2. When the information provider has no particular intention (related information), the intention (related information) for the information is not recorded in the intention (related information) memory unit 2c.

FIG. 5 shows an exemplary information to be stored by the intention (related information) memory unit 2c inside the server 2. The intention (related information) of the information provider is recorded in correspondence to the identifier assigned to the information. The intention (related information) “high” is attached to the information A, which indicates the intention (related information) of the information provider for desiring to provide the information in high quality. No intention (related information) is attached to the information B, which indicates that the information provider has no particular intention (related information) for this information.

In the information transmission and reception system of this embodiment, when there is an intention (related information) of “high” to indicate the desire to provide the information in high quality, it implies the intention (related information) for desiring to deliver the information to the information receiving device 25 via the 802.11 network interface 22, and when there is an intention (related information) of “low” to indicate the quality of the information may be poor, it implies the intention (related information) for desiring to deliver the information to the information receiving device 25 via the Bluetooth (registered trademark) network interface 23. When there is no intention (related information), it implies the intention (related information) that the information can be delivered via either one of the 802.11 network interface 22 and the Bluetooth (registered trademark) network interface 23.

Also, the intention (related information) memory unit 2c can notify the intention (related information) that the quality of the information is important or that the quality of the information is unimportant, to one or more of the access points 21 within the information transmission and reception system, and the access point 21 that is notified of the intention (related information) can connect the information receiving device 25 to either one of the 802.11 network interface 22 and the Bluetooth (registered trademark) network interface 23 at higher priority according to that intention (related information).

FIG. 7 shows an operation of the server 2 when a request from the information receiver is received. First, at the step S11, the server 2 is in a state of waiting for a request from the information receiver. When the request from the information receiver arrives via the access point 21, the request processing unit 2d inquires the presence/absence of the information to the information management unit 2a at the steps S12 and S13. When the information is stored, the request processing unit 2d receives the identifier and the stored location attached to the information from the information management unit 2a at the step S15.

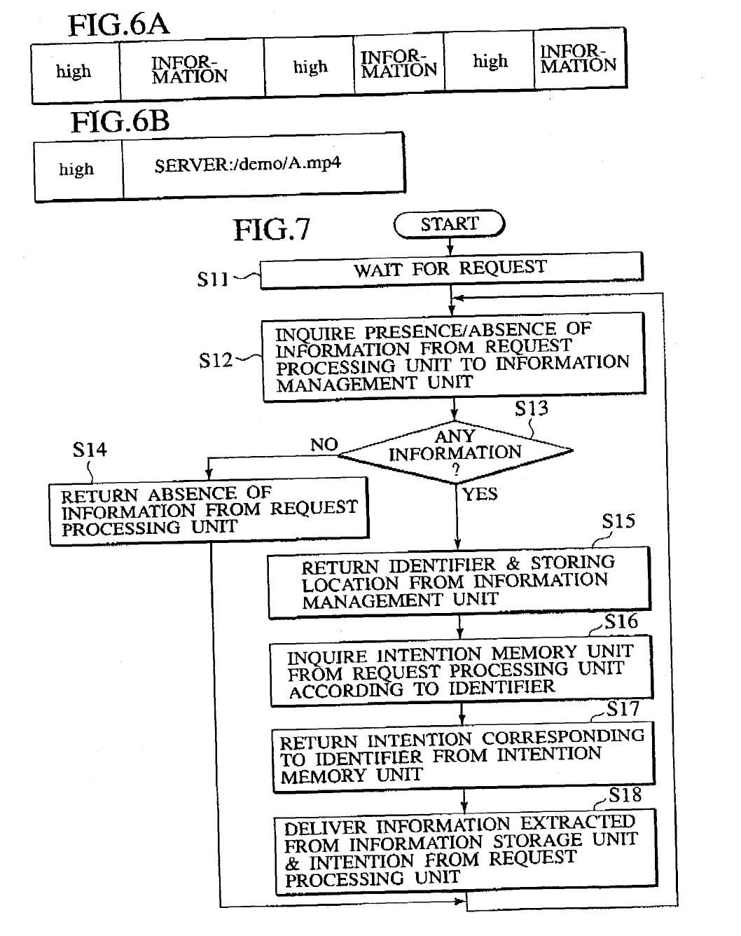

Then, at the step S16, the request processing unit 2d inquires the intention (related information) of the information provider to the intention (related information) memory unit 2c according to the received identifier. Then, at the step S17, the intention (related information) memory unit 2c returns the intention (related information) corresponding to the identifier to the request processing unit 2d. Then, at the step S18, the request processing unit 2d carries out the stream delivery of the information along with the intention (related information) of the information provider received from the intention (related information) memory unit 2c, to the access point 21 through which the request is received. The delivery of the intention (related information) and the information can be made in a form of attaching the intention (related information) at a top of the information as shown in FIG. 6A, or separately by attaching information indicating related information to the intention (related information) as shown in FIG. 6B.

Note that, when the information requested by the request is absent at the step S13, the information management unit 2a replies that the information is absent to the request processing unit at the step S14. Then, the request processing unit 2d notifies that the information is absent to the information receiver via the access point 21. At this point, it is possible to notify just the fact that the information is absent, or that the information is absent but information related to the request is present. Else, it is also possible to notify that the information is absent, along with a totally unrelated information. This last example is the case of delivering the advertisement, for example.

Next, the information receiving device 25 owned by the information receiver will be described.

The information receiving device 25 owned by the information receiver can have one or a plurality of network interfaces. In the case of having a plurality of network interfaces. It is preferable to have network interfaces with different speeds or properties as the network interfaces such as the 802.11 network interface and the Bluetooth (registered trademark) network interface, but it is also possible to have a plurality of the same network interfaces. In this embodiment, the information receiving device 25 owned by the information receiver has the 802.11 network interface 22 and the Bluetooth (registered trademark) network interface 23.

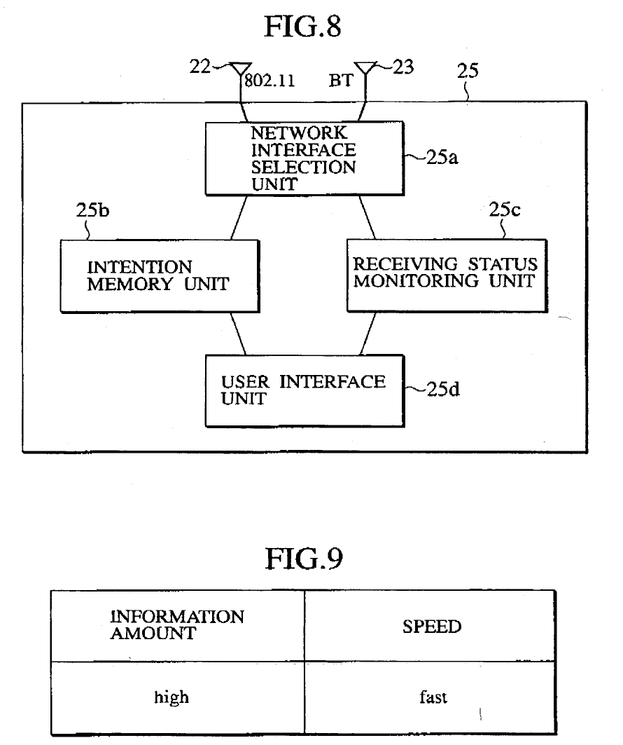

FIG. 8 shows a configuration of the information receiving device 25 owned by the information receiver in this embodiment. In this embodiment, the information receiving device 25 owned by the information receiver has the 802.11 network interface 22, the Bluetooth (registered trademark) network interface 23, a network interface selection unit 25a for selecting the network interface to be used, an intention (related information) memory unit 25b for storing the intention (related information) of the information receiver, a receiving status monitoring unit 25c for monitoring whether it is in a state capable of receiving information or not, and a user interface unit 25d for realizing a user interface with respect to the information receiver.

Note that, in the case where the information receiving device 25 has a plurality of network interfaces, this fact may or may not be explicitly notified to the user interface unit 25d. Also, when a plurality of network interfaces exist, which network interface is to be used for transmission and reception of information may be selected by the network interface selection unit 25a according to the situation or the information receiver may select the network interface to be used explicitly.

The receiving status monitoring unit 25c has a function for inquiring whether there is an accessible access point 21 in a vicinity either regularly or irregularly, a function for notifying the accessible access point 21 to the network interface selection unit 25a when the accessible access point 21 is discovered as a result of the inquiry, a function for notifying the likelihood of being disconnected when the information receiving device 25 is moving away from a vicinity of the access point 21 as in the case where the information receiver who owns the information receiving device 25 is moving around while the information receiving device 25 is connected to the access point 21, and a function for notifying the disconnection when the information receiving device 25 has moved to outside of a radio reaching zone of the access point 21.

The network interface selection unit 25a has a function for receiving a notice from the receiving status monitoring unit 25c when the access point 21 in a vicinity of the information receiving device 25 is discovered, and making a connection to the access point 21 by selectively using the specified network interface in this case, according to the intention (related information) or the information provider transmitted from the server 2 via the access point 21 or the intention (related information) of the information receiver stored in the intention (related information) memory unit 25b, and a function for notifying that it becomes possible to receive information, to the user interface unit 25d. Note that it is also possible to use a configuration in which the connection to the access point 21 is made by selectively using the specified network interface according to the intention (related information) of the information receiver stored in the intention (related information) memory unit 25b.

The intention (related information) memory unit 25b has a function for receiving the intention (related information) of the information receiver through the user interface unit 25d and storing it. The intention (related information) of the information receiver can specify an information amount, a speed for obtaining information, a refusal for receiving information that is not desired to be received, etc. FIG. 9 shows an exemplary intention (related information) to be stored in the intention (related information) memory unit 25b. The intention (related information) stored by the intention (related information) memory unit 25b includes the information amount, the transmission speed, etc., as shown in FIG. 9.

Note that, when there is no particular intention (related information), the information receiver may not store the intention (related information) in the intention (related information) memory unit 25b. When it is desired to change the intention (related information), the new intention (related information) may be overwritten via the user interface unit 25d. Also, the intention (related information) memory unit 25b may have a function for deleting the stored intention (related information). In this case, the information receiver can delete the stored intention (related information) via the user interface unit 25d.

Also, the intention (related information) memory information 25b may also store a profile such as the preference of the information receiver in addition to the information for selecting the network interface, and the intention (related information) memory unit 25b may determine the information to be received according to that profile.

The user interface unit 25d is an element for controlling the interface with respect to the information receiver, which has a function for notifying whether the transmission and reception of information is possible or not, a function for displaying the delivered video information, a function for reproducing the delivered audio information, a function for requesting the stopping, the pausing, or the resuming of the video or audio information delivery to the server, and a function for enabling the information receiver to input the intention (related information).

The function for displaying video can be realized by converting the delivered video information into displayable format by the hardware or software processing and displaying it on a liquid crystal display, an Electro-Luminescence display, etc.

The function for reproducing audio can be realized similarly by converting the delivered audio information into a reproducible format by the hardware or software processing and playbacking it on a speaker, a headphone, a headset, etc.

The input by the information receiver can be realized by using a keyboard, a mouse, a headset, a speech input using a microphone, etc. In the case of the speech input, the speech recognition can be realized by the hardware or software installed into the device, or the speech can be transmitted to the access point 21 or the server 2 and recognized at the access point 21 side or the server 2 side.

Note that, when the transmission and reception of information becomes possible, a notice comes from the network interface selection unit 25a, and it is also possible to receive information directly without notifying the information receiver. Also, in the case where it is possible to receive a plurality of types of information, it is possible to present types of information that can be received to the information receiver, or it is possible to utilize a profile storing the preference or the like of the information receiver and directly receive information closest to the content of the profile among a plurality of types of information.

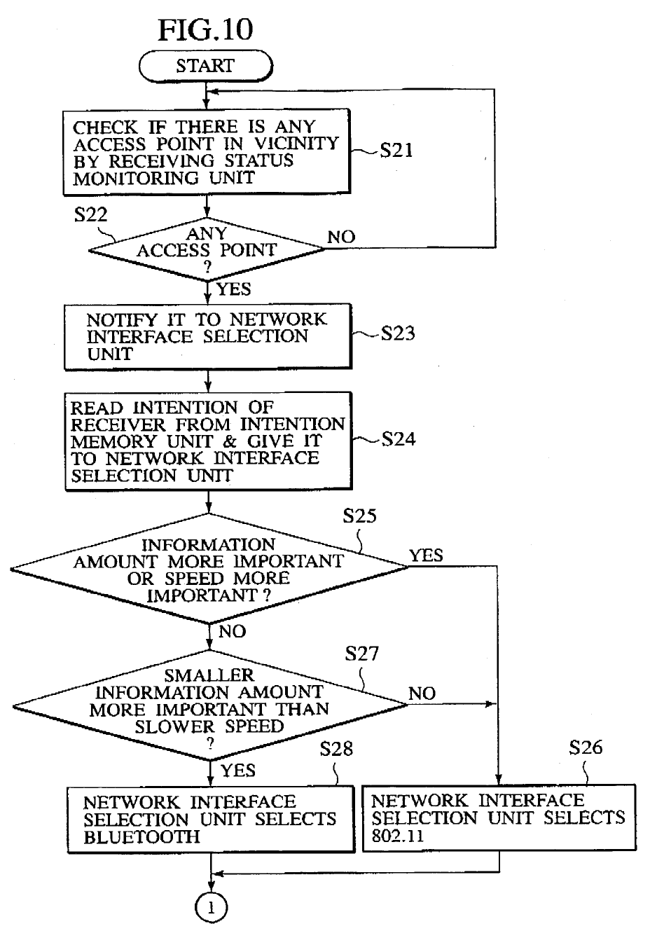

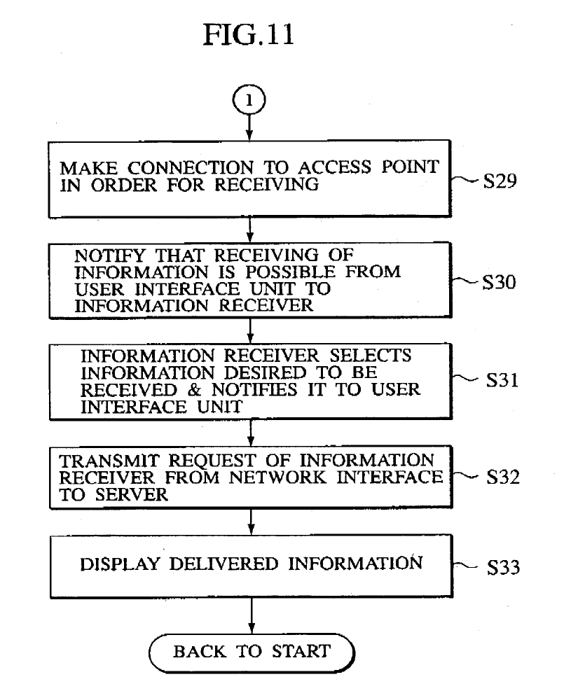

FIG. 10 and FIG. 11 show the basic operation of the information receiving device 25 owned by the information receiver in this embodiment. Note that, in this example, it is assumed that the intention (related information) of the information provider and the intention (related information) of the information receiver are coinciding.

First, at the steps S21 and S22 of FIG. 10, the receiving status monitoring unit 25c inside the information receiving device 25 checks whether the access point 21 exists in a vicinity of the information receiving device 25 or not. When the information receiving device 25 reaches inside a radio reaching zone of the access point 21 to which the information receiving device 25 is accessible, the receiving status monitoring unit 25c detects that the transmission and reception of information became possible, and notifies it to the network interface selection unit 25a at the step S23.

The network interface selection unit 25a reads out the intention (related information) of the information receiver stored in the intention (related information) memory unit 25b at the step S24, and selects the network interface according to the read out intention (related information), and notifies that the transmission and reception of information became possible to the information receiver through the user interface unit 25d. In this embodiment, the 802.11 network interface 22 is selected when the intention (related information) of the information receiver indicates the information amount or the speed for obtaining information as important, and the Bluetooth (registered trademark) network interface 23 is selected otherwise, at the steps S25, S26, S27 and S28. Also, the Bluetooth (registered trademark) network interface 23 is selected when the intention (related information) or the information receiver indicates the smaller information amount or the slower speed as important, at the steps S25, S26, S27 and S28.

When the transmission and reception of information became possible at the step S29 of FIG. 11, the user interface unit 25d notifies this fact to the information receiver by using characters, image, sound, etc., at the step S30. When the information receiver selects information desired to be received at the step S31, the user interface unit 25d transmits a request to deliver that information to the server 2 via the network interface selected by the network interface selection unit 25a at the step S32. The server 2 that received the request starts the delivery of that information, and as a result, the delivered information is displayed at the information receiving device 25 at the step S33. Then, the operation returns to the step S21.

The above description of the operation is for the case where the intentions (related informations) of the information provider and the information receiver coincide, but there can be cases where they are different. In such a case, the network interface selection unit 25a makes a connection to the access point 21 by using the 802.11 network interface 22 when the intention (related information) of the information provider indicates the information amount as important. If the information receiving device 25 is currently connected by using the Bluetooth (registered trademark) network interface 23, this connection is disconnected once and a new connection is made by using the 802.11 network interface 22.

Also, the network interface selection unit 25a selects the Bluetooth (registered trademark) network interface 23 when the information provider has no particular intention (related information) or when the intention (related information) of the information provider indicates the smaller information amount as important.

In the above description, the intention (related information) of the information provider is given a higher priority, but conversely it is also possible to give a higher priority to the intention (related information) of the information receiver. In such a case, the network interface selection unit 25a selects the 802.11 network interface 22 when the intention (related information) of the information receiver indicates the information amount or the speed for obtaining information as important, regardless of the intention (related information) of the information provider, and the network interface selection unit 25a selects the Bluetooth (registered trademark) network interface 23 when the intention (related information) of the information receiver indicates the smaller information amount or the slower speed as important or when the information receiver has no particular intention (related information).

Also, there is an upper limit to the number of devices accessible to the access point 21, so that there can be cases where the connection cannot be made as the number of accessible devices already reached the upper limit, even it the information receiver intends the connection by using the 802.11 network interface 22. In such a case, the network interface selection unit 25a can select the Bluetooth (registered trademark) network interface 23 instead of the 802.11 network interface 22 and makes the connection to the access point 21, or the network interface selection unit 25a can notify that the 802.11 network interface 23 cannot be utilized to the information receiver through the user interface unit 25d without making a connection by using the Bluetooth (registered trademark) network interface 23.

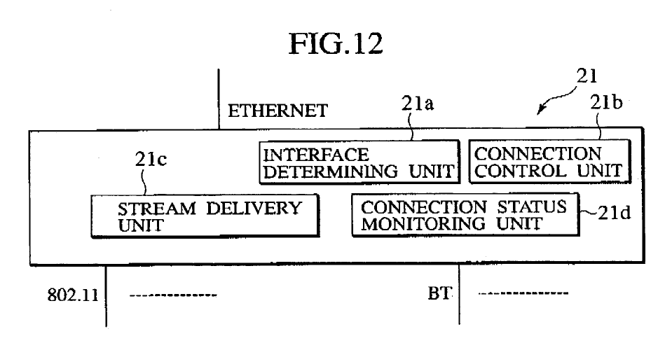

Finally, the access point 21 according to this embodiment will be described with reference to FIG. 12.

FIG. 12 shows a configuration of the access point 21 according to this embodiment. In this embodiment, as shown in FIG. 12, the access point 21 has one or a plurality of each one of 802.11 network interface, Bluetooth (registered trademark) network interface, and Ethernet (registered trademark) interface. The Ethernet (registered trademark) interface is used for communications with the server 2 in this embodiment, but besides the Ethernet (registered trademark), a network connecting the server 2 and the access point 21 can be IEEE 1394, ATM, radio network, public network used by the wired telephone or the portable telephone, etc.

The access point 21 in this embodiment has an interface determining unit 21a having a function for determining which network interface of the access point 21 should be selected by accounting for the intention (related information) of the information provider, a connection control unit 21b having a function for dynamically changing the upper limit of the number or accessible devices, securing the network bandwidth, and connecting the interface by accounting for the intention (related information) of the information provider, a stream delivery unit 21c having a function for carrying out the stream delivery of video and audio information delivered from the server 2 to the information receiving device 25, and a connection status monitoring unit 21d having a function for comprehending how many information receiving devices are connected to each network interface.

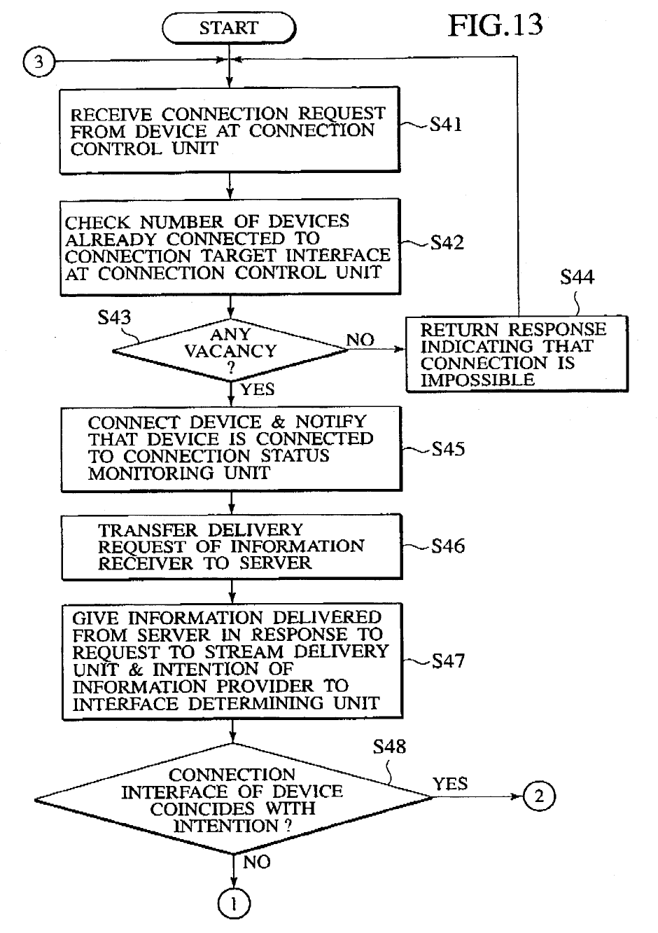

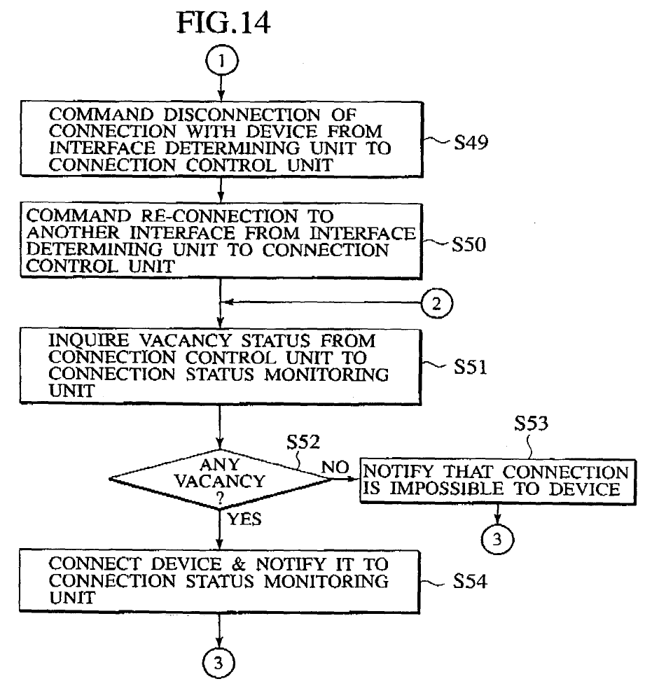

FIG. 13 and FIG. 14 show the processing at the access point 21 when the information receiving device 25 makes a connection to the access point 21.

When a connection request from the information receiving device 25 comes, the connection control unit 21b checks the number of devices already connected to the connection requested network interface at the steps S41 and S42 of FIG. 13, and if there is a vacancy, the connection is made and the fact that the connection is made is notified to the connection status monitoring unit 21d at the steps S43 and S45 of FIG. 13. Note that If there is no vacancy, the connection control unit 21b returns a response indicating that the connection is impossible to the information receiving device 25 at the step S44, and the processing returns to the step S41.

Then, when an information delivery request is transmitted from the information receiving device 25, the request is transferred to the server 2 through the Ethernet (registered trademark) at the step S46 of FIG. 13. Then, when the information is delivered along with the intention (related information) of the information provider from the server 2, that information is given to the stream delivery unit 21c while that intention (related information) is given to the interface determining unit 21a at the step S47.

Next, at the step S48 of FIG. 13, the interface determining unit 21a checks whether the interface connected to the information receiving device 25 coincides with the intention (related information) of the information provider or not. When they coincide, the processing proceeds to the step S51 of FIG. 14.

When the information receiving device 25 is connected to the interface different from the intention (related information) of the information provider, the interface determining unit 21a commands the disconnection of the connection with the information receiving device 25 to the connection control unit 21b at the step S49 of FIG. 14. Then, at the step S49 of FIG. 14, the connection control unit 21 negotiate with the information receiving device 25 to disconnect the connection once, and notifies the disconnection to the connection status monitoring unit 21d. Then, at the step S50 of FIG. 14, the interface determining unit 21a commands the re-connection with the other network interface to the connection control unit 21b. Then, at the step S51, the connection control unit 21b inquires the vacancy status to the connection status monitoring unit 21d. If there is a vacancy, the connection with the information receiving device 25 is made, and this fact is notified to the connection status monitoring unit 21d at the steps S52 and S53. Then, the processing returns to the step S41 of FIG. 13.

Note that, at the step S52, if there is no vacancy at the other network interface, the fact that the connection is impossible is notified to the information receiving device 25 at the step S53, and the processing returns to the step S41. Alternatively, the access point 21 may refuse the connection by forcefully disconnecting the connection, or may make the connection without changing the network interface and deliver the information.

Also, when the information receiving device 25 newly issues the connection request in the state where the information receiving devices less than the upper limit number of accessible devices are connected, the connection control unit 21b may return a response indicating that there is no vacancy at the interface in order to reserve the capacity to connect several other devices. In this case, when the information receiving device newly issues the connection request for the other interface later on, makes the connection and issues the information delivery request but it is connected with the interface different from the intention (related information) of the information provider, it is possible to disconnect the connection once and make the re-connection with the reserved interface side, so as to account for the intention (related information) of the information provider.

The connection between the access point 21 and the information receiving device 25 can be disconnected, but the connection status monitoring unit 21d checks the devices connected to each interface of the access point 21 either regularly or irregularly, and if a disconnected device is discovered, this fact is notified to the connection control unit 21b.

In the above described embodiment, the access point 21 connects the information receiving device 25 by giving a higher priority to the intention (related information) of the information provider, but conversely it is also possible to give a higher priority to the intention (related information) of the information receiver. In such a case, the connection control unit 21b simply manages the number of the information receiving devices connected to each interface of the access point 21, if there is any vacancy, makes the connection according to the connection request from the information receiver, or if there is no vacancy, notifies this fact to the information receiving device 25. Note that there can be cases where there is no vacancy at the network interface intended by the information receiver, and in such a case, the connection control unit 21b may check whether there is any other accessible interface with a vacancy or not, and if there is, make the connection with that interface.

Also, in the above described embodiment, the access point 21 has both the 802.11 network interface and the Bluetooth (registered trademark) network interface, but it is also possible to provide one or a plurality of each one of the access point having only the 802.11 network interface and the access point having only the Bluetooth (registered trademark) network interface, together in a vicinity.

Note that, in order to notify the intention (related information) of the information provider side to the information receiver side, the following method can be used.

(1) First, the intention (related information) of the information provider side (server side) is embedded into a display to be presented to the information provider. For example, selection buttons for “Bluetooth (registered trademark) specification”, “Exemplary Bluetooth (registered trademark) products”, and “What is Bluetooth (registered trademark)?” can be provided in the display of the display unit such that the user call make a selection. If the data corresponding to these options are “specification=text”, “exemplary Bluetooth (registered trademark) products=still pictures”, and “what is Bluetooth (registered trademark)?=video”, the server side embeds the intention (related information) such as “Bluetooth (registered trademark) specification=Low”, “exemplary Bluetooth (registered trademark) products=Middle”, and “what is Bluetooth (registered trademark)?=High” into the respective buttons in advance.

(2) When the information receiver pressed the button for “Bluetooth (registered trademark) specification”, the terminal (information receiving device 25) recognizes that the intention (related information) of the server 2 is “Low”, and selects the Bluetooth (registered trademark) network interface as the interface for sending the request for information. When the information receiver pressed the button for “What is Bluetooth (registered trademark)?”, the terminal (information receiving device 25) recognizes that the intention (related information) of the server 2 is “High”, and selects the 802.11 network interface as the interface for sending the request for information. When the information receiver pressed the button for “exemplary Bluetooth (registered trademark) products”, the terminal (information receiving device 25) monitors the interface status and selects either the request should be transmitted from the Bluetooth (registered trademark) network interface or the request should be transmitted from the 802.11 network interface.

(3) in order to enable the terminal side to make the selection as described above, the server 2 and the terminal (information receiving device 25) are operated such that one request completes one session. In other words, the data are transmitted after selecting a route and establishing a session for each request.

As described above, according to this embodiment, it becomes possible to deal with various demands of the information provider and the information receiver, by providing a plurality of radio interfaces or the like with different properties at the server 2, the access point 21, and the information receiving device 25 owned by the information receiver, and equipping the server 2, the access point 21, and the information receiving device 25 with a function for accounting for the intentions (related information) of the information provider and the information receiver.

For example, it becomes possible for the information provider to provide the information in a desired form by relating the intention (related information) regarding the quality and the quantity of the information to be provided (ranging from higher quality of image/sound=higher bit rate to least minimum quality of image/sound for conveying the information=lower bit rate), to the information.

It is possible for the information receiver to determine the information amount and the speed of the information desired to be received depending on the place, time, etc. The information amount can indicate the detailed information, the normal information, the simpler information, etc., and the speed can indicate a desire to obtain the information quickly or a desire to obtain the information even if it is slowly. In this way, it becomes possible to receive the information in a desired form of the information receiver.

Also, the intention (related information) of the information provider can be accounted for by setting the priority level to the information provided at the server 2 side and setting the upper limit to the number of accessible devices for each network interface at the access point 21. When there is the intention (related information) for desiring to provide the contents at high quality, the intention (related information) of the information provider can be realized by setting the upper limit to the number of accessible devices for the Bluetooth (registered trademark) network interface low and connecting the information receiving device 25 to the 802.11 network interface.

Also, in the above described embodiment, either one of the 802.11 network interface 22 and the Bluetooth (registered trademark) network interface 23 is selected according to the information amount and the transmission speed, but it is also possible to select one according to the power consumption, the fee, etc. For example, it is possible to select the 802.11 network interface 22 when the large power consumption or the high fee is acceptable at the information receiving device 25, and select the Bluetooth (registered trademark) network interface 23 when the smaller power consumption or the lower fee is preferable.

As described above, according to the present invention, it becomes possible to deal with various demands of the information provider and the information receiver even when the information amount that can be transmitted and received varies.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An information providing device for providing information of an information provider to an information receiver through a network and a plurality of relay devices connected to the network, each relay device having at least one or two or more different radio interfaces, the information providing device comprising:
an information storage unit configured to store the information;
an information management unit configured to manage the information stored in the information storage unit;
a related information memory unit configured to store a related information for selecting one of the different radio interfaces when the information provider transmits the information to the information receiver; and
a processing unit configured to carry out a processing when a transmission request for the information is received from the information receiver, to inquire whether the information is stored or not to the information management unit, receive the information from the information storage unit if the information is stored, receive the related information for the information from the related information memory unit, and transmit the information through one relay device that has one radio interface specified by the related information.

2. The information providing device of claim 1, further comprising a checking unit configured to check a radio interface possessed by the information receiver,
wherein the processing unit transmits the information only when the information receiver possesses the one radio interface specified by the related information of the information to be transmitted, through the one relay device that has the one radio interface.

3. An information providing device for providing information of an information provider to an information receiver through a network and any of a plurality of relay devices connected to the network, each relay device having at least one of two or more different radio interfaces, the information providing device comprising:
an information storage unit configured to store the information;
an information management unit configured to manage the information stored in the information storage unit;
a related information memory unit configured to store a related information for selecting one of the different radio interfaces when the information provider transmits the information to the information receiver;
a detection unit configured to detect that the information receiver entered a radio area covered by some relay devices; and
a processing unit configured to carry out a processing to inquire whether the information related to this radio area is stored or not to the information management unit, receive the information from the information storage unit if the information is stored, receive the related information for the information from the related information memory unit, and transmit the information through one relay device that has one radio interface specified by the related information.

4. The information providing device of claim 3, further comprising a checking unit configured to check a radio interface possessed by the information receiver.
wherein the processing unit transmits the information only when the information receiver possesses the one radio interface specified by the related information of the information to be transmitted, through the one relay device that has the one radio interface.

5. An information receiving device for receiving information of an information provider through a network and any of a plurality of relay devices connected to the network, each relay device having at least one of two or more different radio interfaces, the information receiving device comprising:
a plurality or radio interfaces which are mutually different and to be connected to the relay devices through radio;
an information request unit configured to request a desired information provided by the information provider, through one of the radio interfaces;
a related information receiving unit configured to receive a related information for selecting the one of the radio interfaces, through the one of the radio interfaces, at a time of receiving the desired information;
a receiving status monitoring unit configured to judge whether a communication using one radio interface specified by the related information is possible or not; and
an information receiving unit configured to receive the desired information through the one radio interface, when the receiving status monitoring unit judges that the communication using the one radio interface is possible.

6. The information receiving device or claim 5, further comprising:
a receiving related information memory unit configured to store a receiving related information for specifying the one radio interface to be used at a time of receiving the desired information;
wherein the information receiving unit receives the desired information by selecting the one radio interface specified by either the related information received from the information provider or the receiving related information.

7. An information transmission and reception system comprising:
an information providing device for providing information of an information provider to an information receiver through a network and a plurality of relay devices connected to the network, each relay device having at least one of two or more different radio interfaces; and
an information receiving device for receiving the information;
the information providing device having:
an information storage unit configured to store the information;
an information management unit configured to manage the information stored in the information storage unit;
a related information memory unit configured to store a related information for selecting one of the different radio interfaces when the information provider transmits the information to the information receiver; and
a processing unit configured to carry out a processing when a transmission request for the information is received from the information receiver, to inquire whether the information is stored or not to the information management unit, receive the information from the information storage unit if the information is stored, receive the related information for the information from the related information memory unit, and transmit the information through one relay device that has one radio interface specified by the related information; and
the information receiving device having:
a plurality of radio interfaces which are mutually different and to be connected to the relay devices through radio;
an information request unit configured to request a desired information provided by the information provider, through one or the radio interfaces:
a related information receiving unit configured to receive the related information for selecting one radio interface, through the one of the radio interfaces, at a time of receiving the desired information;
a receiving status monitoring unit configured to judge whether a communication using one radio interface specified by the related information is possible or not; and
an information receiving unit configured to receive the desired information through the one radio interface, when the receiving status monitoring unit judges that the communication using the one radio interface is possible.

8. The information transmission and reception system of claim 7, wherein the information providing device also has;
a checking unit configured to check a radio interface possessed by the information receiver,
wherein the processing unit transmit the information only when the information receiver possesses the one radio interface specified by the related information of the information to be transmitted, through the one relay device that has the one radio interface.

9. The information transmission and reception system of claim 6, wherein the information receiving device also has:
a receiving related information memory unit configured to store a receiving related information for specifying the one radio interface to be used at a time of receiving the desired information;
wherein the information receiving unit receives the desired information by selecting the one radio interface specified by either the related information received from the information provider or the receiving related information.
